(19) United States
(12) Patent Application Publication
(10) Pub. No.: US 2008/0195843 A1
(43) Pub. Date: Aug. 14, 2008

(54) METHOD AND SYSTEM FOR PROCESSING A VOLUME VISUALIZATION DATASET

(75) Inventor: Kovalan Muniandy, Stamford, CT (US)

Correspondence Address: LAW OFFICE OF DELIO & PETERSON, LLC., 121 WHITNEY AVENUE, 3RD FLLOR, NEW HAVEN, CT, 06510, US

(73) Assignee: JAYA 3D LLC, Stamford, CT (US)

(21) Appl. No.: 11/672,581

(22) Filed: Feb. 8, 2007

(51) Int. Cl. G06F 9/38

(52) U.S. Cl. 712/31; 712/E09.049

(57) ABSTRACT

A method of processing a volume visualization dataset. Information is transmitted from a resource manager to a task scheduling module regarding the number of processor nodes and amount of storage available in associated storage devices, and sub-tasks instructions including algorithm modules are transmitted from the task scheduling module to a master processor and multiple slave processor nodes. Portions of the volume visualization dataset are transmitted from data storage devices to RAM accessed directly by the master and slave processor nodes. The sub-task instructions and algorithm modules are executed on the individual master and slave processor nodes by accessing directly the portions of the dataset on their respective RAM. Results are transmitted to the master processor node of the slave processor node execution of any sub-task and algorithm module assigned to the slave node. The results are combined at the master processor node and transmitted to the volume visualization application.

### BACKGROUND OF THE INVENTION

1. Field of the Invention

The present invention relates to computer processing and, in particular, to a method and system for processing a volume visualization dataset to be used by a volume visualization application program.

2. Description of Related Art

Performing computed axial tomography (CT) scans or magnetic resonance imaging (MRI) scans of a patient's body results in large three dimensional volume datasets that typically range in size from 500 MB to 1.5 GB or more. This data normally is stored in a common location on a computer network for use by a volume visualization computer program or application. In order to view such a large dataset it is necessary to transfer the patient data from its storage location to a data processing server, and create viewable images by the volume visualization application on the data processing server. The server may consist of multiple computers that collectively represent a large processing power, which is normally needed to handle such large data in a timely manner. A program residing on a main computer (receiving computer) of the server receives the data and may assign subtasks to each of the other computers in its server pool. A data access bottleneck may occur when the application attempts to access and view such large volume visualization datasets that are not present in its local storage space. For example, a CAT scan of a human body produces a dataset that is 840 MB or bigger in size and is large by current standards. The processors are located physically on different computers, and there have been no good mechanisms that dictate how each of the computers accesses the data that it is to process. In the worst-case scenario, all the data may reside on the receiving computer, thus making each of the other computers request the data from receiving computer. In such case the transfer of data from the receiving computer to other computers in the data processing server becomes the bottleneck that renders the large processing power useless.

Accordingly, there is a need for the processing of large amounts of data without creating bottlenecks that negate the processing power of the computer networks on which the applications run.

### SUMMARY OF THE INVENTION

Bearing in mind the problems and deficiencies of the prior art, it is therefore an object of the present invention to provide an improved method and system for enabling application programs to handle large datasets by computers in its server pool.

It is another object of the present invention to provide an improved method and system for processing a volume visualization dataset to be used by a volume visualization application.

It is yet another object of the present invention to provide a method and system for processing large datasets that enables multiple computer processors operating in parallel to access the data more directly. These computer processors may be one or more of, or a combination of, the central processing unit (CPU) of the computer, and any additional co-processors, which may include field programmable gate arrays (FPGAs), vector processors like the graphics processors, cell processors, or a co-processor embedded in the same physical chip as the CPU. There may be one or more of CPUs and one or more co-processors in a single computer, and also in multiple computers.

A further object of the invention is to provide a method and system for processing large datasets that enables the application programs to control the splitting of tasks among multiple computer processors each assigned to the portion of data to be processed.

Another object of the invention is to provide a method and system (framework) that can be used, by third-party application programs running on servers with one or more computers, to control the merging of results from the tasks performed by each of the multiple computer processors.

Another object of the invention is to provide a method and system (framework) that can be used, by third-party application programs running on servers with one or more computers, to transparently handle the initial transfer of input data to each of the multiple computer processors, and to handle the transfer of results of the tasks performed by each computer processor. The application can control the sources and destinations for the transfer of results from each computer processor to match its merging algorithm, as described above.

Still other objects and advantages of the invention will in part be obvious and will in part be apparent from the specification.

The above and other objects, which will be apparent to those skilled in the art, are achieved in the present invention which is directed to a method of processing a volume visualization dataset to be used by a volume visualization application comprising of providing the volume visualization dataset on one or more data storage devices and providing a task scheduling module having instructions from the volume visualization application. The task scheduling module includes instructions regarding splitting of an application task into sub-task instructions in an algorithm module to be performed by different processor nodes. The task scheduling module is adapted to transmit sub-tasks to at least one of the nodes. The method also includes providing at least one slave processor node adapted to execute an associated algorithm module. Each slave processor node has its own random access memory to access directly at least a portion of the volume visualization dataset on the one or more data storage devices. The method further includes providing a master processor node adapted to execute an associated algorithm module. The master processing node has its own random access memory to access directly at least a portion of the volume visualization dataset on the one or more data storage devices. There is also provided a resource manager for tracking number of processor nodes and amount of storage available in storage devices associated with the nodes. The method then includes transmitting information from the resource manager to the task scheduling module regarding the number of processor nodes and amount of storage available in storage devices associated with the nodes, and transmitting the sub-tasks instructions including the algorithm modules from the task scheduling module to the master processor and at least one slave processor node. Portions of the volume visualization dataset to the used by each of the master processor node and the at least one slave processor node are transmitted from the one or more data storage devices to the random access memory accessed directly by the master processor node and the slave processor node, respectively. The sub-task instructions and algorithm modules are executed on the individual master and slave processor nodes by accessing directly the portions of the volume visualization dataset on the random access memory of the master processor node and the slave processor node, respectively. The method then includes transmitting results from the at least one slave processor node to the master processor node of the slave processor node execution of any sub-task and algorithm module assigned to the slave node; combining at the master processor node the results of execution of sub-tasks and algorithm modules assigned to the master and slave nodes; and transmitting the combined results from the master processor node to the volume visualization application. Alternatively, the task scheduler may provide the instructions for the slave processor nodes to send their results directly to the volume visualization application without having to go through the master processor node. This may the useful in a tiled display where each display unit on the application is driven by a slave node.

The method may further include transmitting instructions from the task scheduling module to the master node regarding combining at the master processor node the results of execution of sub-tasks and algorithm modules assigned to the master and slave processor nodes.

The method may also include transmitting at least some of the sub-tasks instructions, including the algorithm modules, from the task scheduling module directly to the master processor node and to a plurality of slave processor nodes. There is retained on the master node at least one sub-task instruction including at least one algorithm module to perform the sub-task on the master node.

There may be provided a plurality of slave processor nodes, and the method may include combining at one slave processor node results of execution of sub-tasks and algorithm modules by other slave processor nodes, and transmitting combined results from the one slave processor node to the master processing node.

The processor nodes preferably include a central processing unit and a co-processor, which may comprise, for example, a vector processor such as a GPU, a FPGA, a cell processor or a GPU embedded in a central processing unit chip.

The portion of the volume visualization dataset transmitted to random access memory accessed by the master processor node and the random access memory accessed by the at least one slave processor node is preferably used exclusively by the master processor node and the slave processor node, respectively.

Each processor node may have a central processing unit and a co-processor, each with its own random access memory, and each processor node may have access to at least one disk drive data storage device or clustered file system containing the volume visualization dataset. The volume visualization dataset may be split between random access memory devices of the central processing unit and co-processor on the master and slave processor nodes to execute the sub-task instructions and algorithm modules thereon.

The method is particularly useful where the volume visualization dataset comprises of three-dimensional data from a medical imaging scan of a patients body.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a schematic view of the preferred hardware used for processing a volume visualization dataset to be used by a volume visualization application, in accordance with the present invention.

FIG. 2 is a schematic view of the preferred functional system framework for processing a volume visualization dataset to be used by a volume visualization application, in accordance with the present invention.

FIG. 3 is a schematic view of an example of processing of a volume visualization dataset for use by a volume visualization application in accordance with the present invention.

### DESCRIPTION OF THE PREFERRED EMBODIMENT(S)

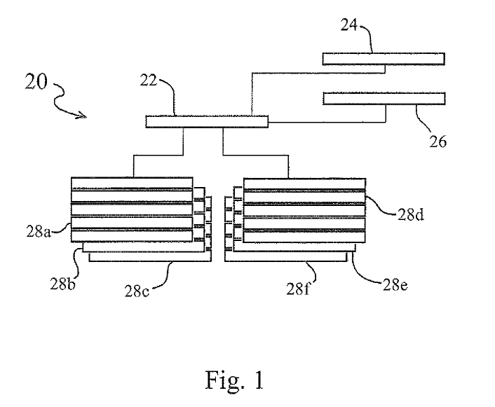

In describing the preferred embodiment of the present invention, reference will be made herein to FIGS. 1-3 of the drawings in which like numerals refer to like features of the invention.

The present invention is directed to a method and system that provides a framework that avoids bottlenecks in processing of large volume visualization datasets by a computer application program using the system. The present invention allows each of the computers in the system to receive independently from the storage server its portion of the data that it is to process. The result of the portion of the processed work by each of the computers, i.e., the subtask, is collected by a main computer and combined, so that the main computer delivers the cumulative result to the application and end user. In another embodiment, the sub-tasks are collected and combined within a subset of computers, and these subset results are then collected and combined at the main computer.

In particular, the present invention provides a method and system for use by a desired application to enable the collocation of data with a sub-processing unit in a parallel computing environment. The system preferably includes a resource manager for keeping track of the computers and their available resources, for accepting a job request from a client application. The application itself supplies a task scheduler module that contains the policy on how a job to be performed by the application is to be split among the several nodes into the subtasks and the policy on how to select and allocate resources, such as designation of master and slave nodes (discussed further below), informing each computer or sub-processing unit that does the subtask, and at least two computer processors, also called computational nodes, that perform the subtask and also handle communication between nodes, or between a node and the application, as well as the algorithm module that runs on each node and is used to perform each subtask. A master node collects the results of the various subtasks result, combines and pieces the results together, and delivers the cumulated result to the application and end user.

A portion of the preferred hardware employed in the method and system of the present invention is shown in FIG. 1. The hardware of system 20 includes computational nodes and memory combined onto individual units 28a through 28f. A greater or fewer number of such units may be employed. Each computational node may be one or more, or a combination, of traditional central processing units (CPU), such as a Pentium 4 or a Core Duo processor available from Intel Corporation of Santa Clara, Calif., a vector processor like a graphics processing unit (GPU), such as the G71 processor available from NVIDIA Corporation of Santa Clara, Calif., or an FPGA processor, such as Virtex-5 available from Xilinx, Inc. of San Jose, Calif. Vector processors such as the GPUs described above are highly parallel single instructions multiple data (SIMD) processors. While reference is made herein to examples employing GPUs, other vector processors may also be used. Preferably, a co-processor to the CPU is employed in each computational node, such as a vector processor, FPGA, cell processors, or a co-processor embedded in the same physical chip as the CPU.

GPUs are preferably employed in the present invention for speed because the vector processing instructions typically are smaller in size than those used in CPUs, but with more repetitions. As an example, a single computer system can be fitted with four GPUs, so that two computers may serve as a high performance computing (HPC) system of one teraflop performance. This is equivalent to having fifty to one hundred Pentium 4 class computers linked together. More than four GPUs can be fitted in a single computer with higher performance switches. Preferably, each of the multiple processor nodes employs a CPU in combination with a CPU, wherein the CPU provides instructional commands for the GPU to process, to form a HPC system. More preferably, each node includes multiple CPUs, each CPU having an associated CPU.

A storage system is accessible by each node and preferably comprises a redundant array of independent disks (RAID). Each RAID storage unit is an assembly of disk drives, known as a disk array, that operates as one storage unit. In general, a RAID system may be any storage system with random data access, such as magnetic hard drives, optical storage, magnetic tapes, and the like. Each array is addressed by the host CPU or CPU computer processor node as one drive. In use in the present invention, the collocation of subtask data with its own processing unit permits the system to use multiple nodes to create a parallel computing environment. The storage units accessible by the different nodes can be combined and made accessible as a single storage file server by using a clustered file system as is well known in the art to create one large storage system. In addition to the storage access, each node unit 28a through 28f includes its own dedicated microcircuit-based random access memory (RAM) which can both be written to and read from more quickly than disk drives. Each CPU and GPU on a node unit may have its own RAM for executing subtask instructions, which will be explained further below.

A high speed switch 22 links each of the node units 28a-28f to a primary controller 24 that directs access to the CPUs/GPUs in the nodes. A back-up controller 26 is provided to take over if primary controller 24 fails. A motherboard that recognizes graphics card over PCI-express switch is preferably used to support the use of multiple graphics card in one computer node. For example, a graphics card may actually have two GPUs, both connected through a single PCI-express slot by using a 1-to-2 switch. Not all motherboards may recognize the switch used in such a graphics card. Other motherboards can be used as well. Additionally, fans and shroud, or water-cooled solutions, should preferably be provided to cool the high heat produced by processors, memory chips and graphics cards, and redundant power supply and hot swappable fan and hard drive components should preferably be provided to minimize operational downtime.

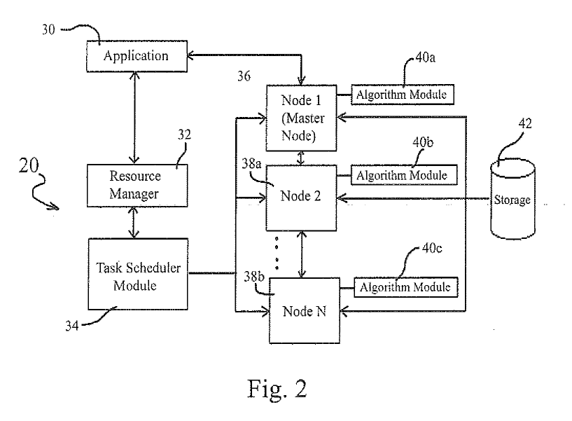

FIG. 2 is a schematic overview of the preferred system framework of the present invention. The server system 20 includes a resource manager 32 to receive a job request from a user application. The resource manager also keeps track of the number of resources available such as the number of computer nodes, the computational processing power and storage capacity associated with each of the computer nodes. The computational processing power is determined by the number of CPUs and GPUs in the computer processor nodes (discussed further below).

Server system 20 also includes a task scheduler module 34 that uses instruction input to it to assign resources for a given job, to split the job into subtasks, and send this information to direct the one or more computer nodes that work on the subtasks. The computer processor nodes actually perform the subtask and include a master node 36 and at least one slave node 38a. One or more additional slave nodes 38b may be provided in communication with the master node. Master node 36 handles communication with and between the nodes 38a, 38b, and with and client application 30. The slave nodes may also communicate with each other. Each node 36, 38a, 38b includes an algorithm module that runs on the node to perform a subtask. Preferably, each processor node also has access to its own RAM, as described in connection with node units 28a-28f (FIG. 1), as well as access to one or more storage devices. The master node is able to collect the result of the subtasks run on it and the additional slave nodes, combine the results together, and deliver the accumulated result to client application 30 and the user. A slave node may also collect the result of the subtasks run on it and one or more additional slave nodes, to combine these results together, and deliver the accumulated result to the master node, or another slave node, for further combination. Alternatively, each slave node can also send the results of the subtasks run on it directly to the application 30.)

The algorithm module on each node is a custom module that employs so-called plug-and-play software instructions written or otherwise provided by the application program. How an application solves a particular problem is dependent on the particular application, and the application writer is responsible for writing the instructions for determining how a problem is solved. The system framework of the present invention accept such custom software to create a processing thread to permit each of the multiple CPUs and/or GPUs in the system to perform a portion of the task, or sub-task, in parallel. To take advantage of GPUs available on the system, the algorithm module should provide a graphics routine written to run on the GPU, as well as the data to be processed registered into the GPU memory.

Initially, a user provides with an application program 30: 1) the dataset to be processed, 2) a task scheduler with instructions regarding how the task of processing the dataset is to be performed by the application is to be split into the subtasks among a plurality of processor nodes, 3) an algorithm module to perform the sub-task for each of the nodes and 4) instructions as to how to combine sub-tasks and algorithm results at the end.

In running the client application program, the client sends a job request to the resource manager 32, which then contacts the task scheduler 34 with this information. The task scheduler 34, using its input instructions which are supplied by the application, calculates the number of processor nodes the application will need for this job request, and then reserves the required number of nodes. It also splits up the job into sub-tasks for each reserved nodes (master and slave), and sends this information and the algorithm module name directly to the corresponding node. Resource manager 32 returns the address of a single computer, master processor node 36, with which the application 30 is to communicate. The application 30 is then able to contact master node 36 or slave nodes 38a, 38b directly.

The method by which system 20 resources are allocated is dependent on the application instructions. The task-splitting instructions are provided in the task scheduler module 34, which is a part of the application input. It splits the job into smaller tasks that are to be assigned to computer nodes in the system, depending on the resources available. Once task scheduler module 34 has determined the resources it needs and the application program computational task is subdivided into sub-tasks for each of the computer nodes, it communicates this to the master node 36, slave nodes 38a, 38b and other computers needed to perform the task. Such communication is performed by a communication software utility program residing in the system using, for example, http or preferably https protocols for security. Compression and frame to frame coherence may be used to reduce the size of data transmission for more responsiveness.

When splitting the task, each computer node is also assigned the subset of the data it will process, in accordance with the instruction from the application program. This subset of data is preferably loaded from storage device 42 into one or more random access memory located adjacent to, and more preferably for the exclusive use of, the central processing unit and/or co-processor of each processor node. Alternatively, the data subset location on one or more common storage devices 42 is provided to the particular computer processor node that will use the data subset, which then accesses and copies the data subset from the common storage device 42 to the adjacent random access memory.

When using the preferred CPUs in the nodes, a resident GPU program resident on each node invokes an initialization routine prior to executing the algorithm module for that particular node. The algorithm module registers the GPU program and the data subset with the GPU during this time. Once registered, the CPU program can be invoked to complete the execution of the graphics routine for each of the GPUs. Upon completion of the rendering by the GPU, the algorithm module calls the composite routine, which combines and merges results from the CPU and GPU sub-task computation, together with results from other nodes. This can be done in the front to back order, back to front order, or out of order. The composite routine may be run only on the master node, or may be run also on the slave nodes. For an example of the latter, there may be four (4) nodes, master node 0, and slave nodes 1, 2 and 3. Node 0 can merge sub-task results from 0 and 1, and node 2 can merge results from 2 and 3. Then node 0 will merge results [0-1] with results [2-3].

Although the GPU program above is described in graphic processing terms, a general algorithm can be written to take advantage of a GPU, known as general processing on GPU (GPGPU). Also, the algorithm module can use other co-processors (general vector adapters, cell processors, or FPGAs etc.) instead of a GPU, while using the same steps of initialization, computation (rendering) and merging (compositing), which are otherwise well known routines.

Each algorithm module obtains the portion of data it uses directly from RAM on its own node, which is downloaded either from storage associated with the node, or from a networked storage on other nodes or from a main storage device. The present invention permits the splitting of data so that the subset of data is retrieved and utilized only by the computer node processing it. The results from each slave node are sent to master node 36 once the subtask is completed. Master node 36 then sends the cumulative result to application 30.

The method of the present invention may be implemented by a computer program or software incorporating the process steps and instructions described above in otherwise conventional program code and stored on an otherwise conventional program storage device. The program code, as well as any input information required, may be stored in any of the storage devices described herein, which may include a semiconductor chip, a read-only memory (ROM), RAM, magnetic media such as a diskette or computer hard drive, or optical media such as a CD or DVD ROM. The storage device may also comprise a combination of two or more of the aforementioned exemplary devices. The computer system employs the processors described above for reading and executing the stored programs.

### EXAMPLE

Volume visualization is an application that requires both high computation power and large amount of storage. An application commences by making a request for resources to render a volume data, for example, a CT-scan of a human body. The request goes to a resource manager on the computer network and the task scheduler module software is invoked. In the task scheduler module, the software splits the volume data into available GPUs and formulates job assignments for computers in the system. The application is notified by the resource manager of a master node to communicate with to solve the problem. The task in this case is to interactively render a 3D volume of the data. Each computer node receives a task assignment and begins loading its portion or subset of the data from the storage device on which it is located (e.g., it is on storage or that on another networked storage device) onto its associated RAM. The loading of the subset volume data is done in parallel, thus reducing the time to load. Once loaded, the data physically resides on RAM next to the processing power, i.e., processor and/or vector processor that works on this data. The smaller subset of volume data is independently processed in parallel for faster completion.

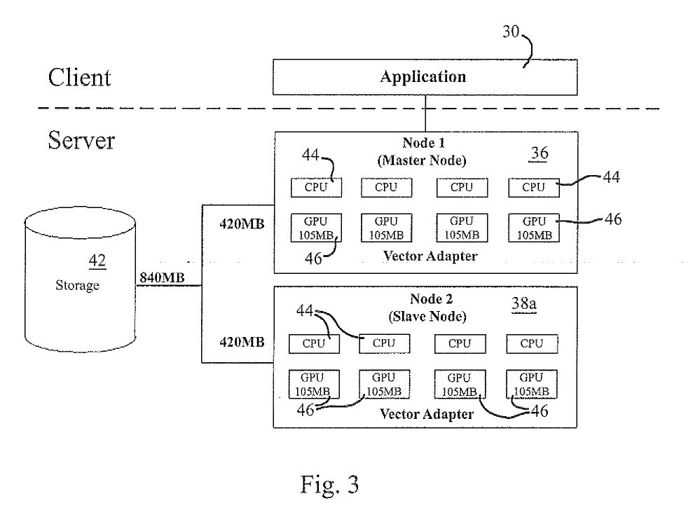

For example, as shown in FIG. 3, an 840 MB volume dataset on storage device 42 is split by a task scheduler module between memory on master node 36 and memory on slave node 38a, and each of the nodes receives instruction to render half the data. The data for each node is then further split into four sub-sets of 105 MB each and given to the RAM associated with each of the four CPUs 44 in nodes 36 and 38a of the system. Each CPU 44 formulates commands to each of the individual GPUs 46 associated with the CPU. Before the GPU can perform the computational task, the 105 MB memory must be in the GPU memory, i.e. copied from the RAM to GPU memory. The copy operation is fast because of a fast PCI-express link between the CPU and GPU. The GPUs 46 perform each of their computational tasks independently and in a parallel manner to produce intermediate results for each sub-set of 105 MB of the volume dataset on the local RAM. The GPU program associated with each node enables each of the GPUs to render results for only one-quarter of the data, 105 MB, handled by each node. A composition routine in the GPU program performs a composition of the results of the sub-tasks to arrive at and deliver the completion of task to application 30. The GPU program in the master node also operates to combine the results from each node. As far as the CPU program and execution is concerned, the master node acts in the same way as the slave node. The master node has the additional responsibility of merging the sub-task results from the slave nodes, and communicating the final result to the application.

Thus, the present invention achieves the objects described above. In addition to the aforedescribed CT scan data, the volume visualization dataset may comprises three-dimensional data from other types of medical imaging scans of a patient's body, for example, magnetic resonance imaging (MRI), ultrasound, positron emission tomography (PET) and nuclear medicine scans such as single photon emission computed tomography (SPECT).

While the present invention has been particularly described, in conjunction with a specific preferred embodiment, volume visualization datasets and volume visualization applications, it is evident that other types of data and applications may be employed, and many alternatives, modifications and variations will be apparent to those skilled in the art in light of the foregoing description. For example, the method and system of the present invention may be used with parallel sorting, such as GPU-ABiSort: Optimal Parallel Sorting on Stream Architectures, BLAS on GPUs, Folding@Home, and the like. It is therefore contemplated that the appended claims will embrace any such alternatives, modifications and variations as falling within the true scope and spirit of the present invention.

Thus, having described the invention, what is claimed is:

1. A method of processing a volume visualization dataset to be used by a volume visualization application comprising:
providing the volume visualization dataset on one or more data storage devices;
providing a task scheduling module having instructions from the volume visualization application regarding splitting of an application task into sub-task instructions in an algorithm module to be performed by different processor nodes, the task scheduling module adapted to transmit sub-tasks to at least one of the nodes;
providing at least one slave processor node adapted to execute an associated algorithm module, each slave processor node having its own random access memory to access directly at least a portion of the volume visualization dataset on the one or more data storage devices;
providing a master processor node adapted to execute an associated algorithm module, the master processing node having its own random access memory to access directly at least a portion of the volume visualization dataset on the one or more data storage devices;
providing a resource manager for tracking number of processor nodes and amount of storage available in storage devices associated with the nodes;
transmitting information from the resource manager to the task scheduling module regarding the number of processor nodes and amount of storage available in storage devices associated with the nodes;
transmitting the sub-tasks instructions including the algorithm modules from the task scheduling module to the master processor node and at least one slave processor node;
transmitting portions of the volume visualization dataset to be used by each of the master processor node and the at least one slave processor node from the one or more data storage devices to the random access memory accessed directly by the master processor node and the slave processor node, respectively;
executing the sub-task instructions and algorithm modules on the individual master and slave processor nodes by accessing directly the portions of the volume visualization dataset on the random access memory of the master processor node and the slave processor node, respectively;
transmitting results from the at least one slave processor node to the volume visualization application, or to the master processor node, of the slave processor node's execution of any sub-task and algorithm module assigned to the slave node;
optionally combining at the master processor node the results of execution of sub-tasks and algorithm modules assigned to the master and slave nodes; and
transmitting results from the master processor node to the volume visualization application.

2. The method of claim 1 further including transmitting instructions from the task scheduling module to the master node regarding combining at the master processor node the results of execution of sub-tasks and algorithm modules assigned to the master and slave nodes.

3. The method of claim 1 including transmitting at least some of the sub-tasks instructions, including the algorithm modules, from the task scheduling module directly to the master processor node and to a plurality of slave processor nodes.

4. The method of claim 1 including providing a plurality of slave processor nodes, and including combining at one slave processor node results of execution of sub-tasks and algorithm modules by other slave processor nodes, and transmitting combined results from the one slave processor node to the master processing node.

5. The method of claim 1 wherein the processor nodes include a central processing unit and a co-processor.

6. The method of claim 5 wherein the co-processor comprises a vector processor, a FPGA, a cell processor or a GPU embedded in a central processing unit chip.

7. The method of claim 1 wherein the portion of the volume visualization dataset transmitted to random access memory accessed by the master processor node and the random access memory accessed by the at least one slave processor node is used exclusively by the master processor node and the slave processor node, respectively.

8. The method of claim 1 wherein each processor node has a central processing unit and a co-processor each with its own random access memory, and each processor node has access to at least one disk drive data storage device or clustered file system containing the volume visualization dataset, wherein the volume visualization dataset is split between random access memory devices of the central processing unit and co-processor on the master and slave processor nodes to execute the sub-task instructions and algorithm modules thereon.

9. The method of claim 1 wherein the volume visualization dataset comprises three-dimensional data from a medical imaging scan of a patient's body.

10. A method of processing a volume visualization dataset to be used by a volume visualization application comprising:
providing the volume visualization dataset on one or more data storage devices, the volume visualization dataset including three-dimensional imaging data;
providing a task scheduling module having instructions from the volume visualization application regarding splitting of an application task into sub-task instructions in an algorithm module to be performed by different processor nodes, the task scheduling module adapted to transmit sub-tasks to at least one of the nodes;
providing a plurality of slave processor nodes, each slave processor node adapted to execute an associated algorithm module, each slave processor node having its own random access memory to access directly at least a portion of the volume visualization dataset on the one or more data storage devices;
providing a master processor node adapted to execute an associated algorithm module, the master processing node having its own random access memory to access directly at least a portion of the volume visualization dataset on the one or more data storage devices;
providing a resource manager for tracking number of processor nodes and amount of storage available in storage devices associated with the nodes;
transmitting information from the resource manager to the task scheduling module regarding the number of processor nodes and amount of storage available in storage devices associated with the nodes;
transmitting the sub-tasks instructions including the algorithm modules from the task scheduling module to the master processor and slave processor nodes;
transmitting portions of the volume visualization dataset to be used by each of the master processor node and the slave processor nodes from the one or more data storage devices to the random access memory accessed directly by the master processor node and slave processor nodes, respectively;
executing the sub-task instructions and algorithm modules on the individual master and slave processor nodes by accessing directly the portions of the volume visualization dataset on the random access memory of the master processor node and slave processor nodes, respectively;
transmitting results from the slave processor nodes to the volume visualization application, or to the master processor node, of the slave processor nodes' execution of any sub-task and algorithm module assigned to the slave nodes;
optionally combining at the master processor node the results of execution of sub-tasks and algorithm modules assigned to the master and slave nodes; and
transmitting results from the master processor node to the volume visualization application.

11. The method of claim 10 further including transmitting instructions from the task scheduling module to the master node regarding combining at the master processor node the results of execution of sub-tasks and algorithm modules assigned to the master and slave nodes.

12. The method of claim 10 including transmitting at least some of the sub-tasks instructions, including the algorithm modules, from the task scheduling module directly to the master processor node and to a plurality of slave processor nodes.

13. The method of claim 10 including combining at one slave processor node results of execution of sub-tasks and algorithm modules by other slave processor nodes, and transmitting combined results from the one slave processor node to the master processing node.

14. The method of claim 10 wherein the processor nodes include a central processing unit and a co-processor.

15. The method of claim 14 wherein the co-processor comprises a vector processor comprising a CPU, a FPGA, a cell processor or a vector processor embedded in a central processing unit chip.

16. The method of claim 10 wherein the portion of the volume visualization dataset transmitted to random access memory accessed by the master processor node and the random access memory accessed by the at least one slave processor node is used exclusively by the master processor node and the slave processor node, respectively.

17. The method of claim 10 wherein each processor node has a central processing unit and a co-processor, each with its own random access memory, and each processor node has access to at least one disk drive data storage device or clustered file system containing the volume visualization dataset, wherein the volume visualization dataset is split between random access memory devices of the central processing unit and co-processor on the master and slave processor nodes to execute the sub-task instructions and algorithm modules thereon.

18. The method of claim 10 wherein the volume visualization dataset comprises three-dimensional data from a medical imaging scan of a patient's body.

19. A method of processing a volume visualization dataset, the dataset including three-dimensional data from a medical imaging scan of a patients body to be used by a volume visualization application comprising:
providing the volume visualization dataset on one or more data storage devices;
providing a task scheduling module having instructions from the volume visualization application regarding splitting of an application task into sub-task instructions in an algorithm module to be performed by different processor nodes, the task scheduling module adapted to transmit sub-tasks to at least one of the nodes;
providing at least one slave processor node adapted to execute an associated algorithm module, each slave processor node having its own random access memory to access directly at least a portion of the volume visualization dataset on the one or more data storage devices;
providing a master processor node adapted to execute an associated algorithm module, the master processing node having its own random access memory to access directly at least a portion of the volume visualization dataset on the one or more data storage devices;
providing a resource manager for tracking number of processor nodes and amount of storage available in storage devices associated with the nodes;
transmitting information from the resource manager to the task scheduling module regarding the number of processor nodes and amount of storage available in storage devices associated with the nodes;
transmitting the sub-tasks instructions including the algorithm modules from the task scheduling module to the master processor and at least one slave processor node;
transmitting instructions from the volume visualization application to the master node regarding combining at the master processor node the results of execution of sub-tasks and algorithm modules assigned to the master and slave nodes;
transmitting portions of the volume visualization dataset to be used by each of the master processor node and the at least one slave processor node from the one or more data storage devices to the random access memory accessed directly by the master processor node and the slave processor node, respectively;
executing the sub-task instructions and algorithm modules on the individual master and slave processor nodes by accessing directly the portions of the volume visualization dataset on the random access memory of the master processor node and the slave processor node, respectively;
transmitting results from the at least one slave processor node to the master processor node of the slave processor node's execution of any sub-task and algorithm module assigned to the slave node;
combining at the master processor node the results of execution of sub-tasks and algorithm modules assigned to the master and slave nodes; and
transmitting the combined results from the master processor node to the volume visualization application.

20. The method of claim 19 including transmitting at least some of the sub-tasks instructions, including the algorithm modules, from the task scheduling module directly to the master processor node and to a plurality of slave processor nodes.
